(19) United States
(12) Patent Application Publication
(10) Pub. No.: US 2018/0056416 A1
(43) Pub. Date: Mar. 1, 2018

(54) METHOD FOR MACHINING THE TOOTH FLANKS OF FACE COUPLING WORKPIECES IN THE SEMI-COMPLETING SINGLE INDEXING METHOD

(71) Applicant: Klingelnberg AG, Zurich (CH)

(72) Inventor: Karl-Martin Ribbeck, Remscheid (DE)

(21) Appl. No.: 15/684,870

(22) Filed: Aug. 23, 2017

(30) Foreign Application Priority Data
Aug. 23, 2016 (EP) 16185237.1

(51) Int. Cl. B23F 15/06; B23F 19/00

(52) U.S. Cl. CPC B23F 15/06; B23F 19/00

(57) ABSTRACT

Semi-completing single indexing methods for machining the tooth flanks of a face coupling workpiece. A tool is used which includes at least one cutting head having two cutting edges or two grinding surfaces. Exemplary methods include executing at least one first relative setting movement, to achieve a first relative setting, finish machining a first tooth flank of a tooth gap of the face coupling workpiece using a first cutting edge or using a first grinding surface of the tool and simultaneously pre-machining a second tooth flank of the second tooth gap using the second cutting edge or using the second grinding surface, executing at least one second relative setting movement, to achieve a second relative setting, and finish machining the second tooth flank of the same or a further tooth gap using a second cutting edge or using the second grinding surface of the tool.

### CROSS REFERENCE TO RELATED APPLICATIONS

This application claims priority under 35 U.S.C. §§119(a)-(d) to European patent application no. EP16185237.1 filed Aug. 23, 2016, which is hereby expressly incorporated by reference as part of the present disclosure.

### FIELD OF INVENTION

The subject matter of the invention is a method for machining the gear teeth of face couplings, wherein it is specifically a semi-completing single indexing method.

### BACKGROUND

Face couplings have a cone angle which is 90°. The face couplings are also referred to as spur gear couplings. face couplings are used, for example, in power plants, on the axles of vehicles, and also, for example, on the camshafts thereof. They are also used in wind turbines. face couplings can be used as permanent couplings, which are distinguished by a fixed, non-positive connection of two coupling elements (also called coupling halves). The two coupling halves can be screwed together with one another or connected in another manner in this case. However, face couplings can also be used as disconnectable couplings (called shift couplings).

A face coupling is not a gear drive, which comprises gearwheels which roll on one another. Therefore, completely different conditions than in gear drives apply both in the production and also during use of face couplings. Thus, the coupling elements of a face coupling cannot be produced by rolling methods. It is also important to know that the coupling elements of a face coupling do not have a constant tooth height in the flank longitudinal direction, which is a result of the manufacturing.

The teeth of the face couplings are to have a high precision and are to enable a maximum load transmission, i.e., a high carrying capacity. The teeth of face couplings have a curved, e.g., spiral-shaped, tooth profile, i.e., the flank longitudinal lines are curved. Upon pairing of two coupling elements, all concave tooth flanks of a first coupling element are engaged simultaneously with all convex tooth flanks of the second coupling element. This means one left-spiral coupling half is paired with one right-spiral coupling half in each case.

Face couplings can be produced in various ways, as described hereafter. A differentiation is made between face couplings which were produced according to the Klingelnberg cyclo-palloid method and according to the Oerlikon method. In addition, there are face couplings which are referred to as Curvic® couplings (Gleason, USA).

The cyclo-palloid method is a continuous method and the teeth of face couplings which were produced according to the cyclo-palloid method have a variable tooth height. In the cyclo-palloid method, two cutter heads are used, which are mounted eccentrically one inside another. Not all machines are capable of accommodating two cutter heads in the manner mentioned. The blades which are used in the cyclo-palloid method are assembled into groups and are arranged on a short section of a multithread spiral on the cutter head. While the cutter heads and the workpiece rotate continuously during the cyclo-palloid method, each new blade group respectively passes through a subsequent tooth gap of the workpiece to be machined. Separate blades are associated with the convex and the concave tooth flanks of the face couplings in the cyclo-palloid method. However, these separate blades are arranged on the same rotation circle radius, if one neglects a small correction value which is necessary to produce a longitudinal crowning. It is a disadvantage of face couplings which were produced according to the cyclo-palloid method that they cannot be hard-fine machined.

The cutter heads which are used in the scope of the Oerlikon method as tools have a complex construction. It is a disadvantage of face couplings which were produced according to the Oerlikon method that they also cannot be hard-fine machined.

In the Curvic® coupling method, the radius of the tool, the number of teeth of the face coupling, and the diameter of the face coupling are dependent on one another. In the Curvic® coupling method, two tooth gaps are always cut simultaneously. Subsequently, the teeth of the face couplings are ground. It is a significant disadvantage of the Curvic® couplings that they necessarily have to have an integer number of teeth. In addition, the teeth of the Curvic® couplings have a constant tooth height.

### SUMMARY

In the industrial production of face couplings, it is, inter alia, also the goal to find simple and rapid methods, because these factors have an influence on the cost-effectiveness.

The object thus presents itself of providing a method for the industrial production of face couplings, which offers more degrees of freedom and is more flexibly usable. In addition, the method is to be more cost-effective than previously known methods.

According to some embodiments, a method is provided which defines a semi-completing single indexing method. A tool is used in this semi-completing single indexing method, which is either a gear cutting tool, which comprises at least one cutting head having two cutting edges, which are arranged on the at least one cutting head so that they define a positive tip width. However, a grinding tool in the form of a cup grinding wheel can also be used in the semi-completing single indexing method, which has two grinding surfaces, which define a positive profile width.

The semi-completing single indexing method may comprise the following steps: A1. executing at least one first relative setting movement, to achieve a first relative setting of the tool in relation to the face coupling workpiece; A2. finish machining of a first tooth flank of a tooth gap of the face coupling workpiece using a first cutting edge of the two cutting edges or using the first grinding surface of the two grinding surfaces of the tool and simultaneously pre-machining a second tooth flank of the same tooth gap the second cutting edge of the two cutting edges or using the second grinding surface of the two grinding surfaces in the first relative setting; A3. executing at least one second relative setting movement, to achieve a second relative setting of the tool in relation to the face coupling workpiece; and A4. finish machining the second tooth flank of the same or a further tooth gap using a second cutting edge of the two cutting edges or using the second grinding surface of the two grinding surfaces of the tool in the second relative setting.

The following statements apply to at least some embodiments for the first relative setting: all first cutting edges or the first grinding surface are moved along a first flight path and all second cutting edges or the second grinding surface are moved along a second flight path, and the first flight path spans a common plane together with the second flight path.

The following statements apply to at least some embodiments for the second relative setting: all second cutting edges or the second grinding surface are moved along a third flight path, the third flight path has a radius which is larger than the radius of the second flight path, and the third flight path spans a plane which is inclined in relation to the common plane.

It is to be noted that the mentioned steps A1 to A4 do not have to be executed in direct succession. Steps A3 and A4 are first executed in at least one embodiment (gap-encompassing semi-completing single indexing method), for example, when all first tooth flanks of all tooth gaps of the face coupling workpiece have been finish machined in the scope of repeating steps A1 and A2 and all second tooth flanks of all tooth gaps have been pre-machined.

The machining of the tooth flanks is performed in at least some embodiments using a constant broaching advance, using a variable broaching advance (for example, degressively decreasing), or using multiple broaching steps.

Since relative movements between tool and face coupling workpiece are executed at different times depending on the method sequence, for example, upon changing of the machine setting, and/or an indexing movement and/or exit and broaching movements of the face coupling workpiece is/are performed partially at the same time, in immediate chronological succession, or at different times, before a further machining step follows, these relative movements are referred to in summary as relative setting movement(s).

A relative setting movement can comprise, in at least some embodiments, for example, the performance of an exiting movement, an indexing movement, and a broaching movement (for example, from a first tooth gap to an immediately adjacent tooth gap) or, for example, only the changing of the machine setting (for example, from a first machine setting to a second machine setting or vice versa). A relative setting movement can also comprise, in at least some embodiments, however, the performance of an exiting movement, an indexing movement, the changing of the machine setting, and the performance of a broaching movement.

In the semi-completing single indexing method, in at least some embodiments, a machine base angle is specified, which is identical in the first and the second machine settings. This machine base angle is specified so that the cutting head/heads of the gear cutting tool is/are guided along an inclined path through the tooth gap of the face coupling workpiece. Similarly, upon use of a cup grinding wheel, the machine base angle can also be specified so that the cup grinding wheel is guided along an inclined path through the tooth gap of the face coupling workpiece.

Depending on the embodiment, the method can have one of the following two method sequences K1 to K4 or L1 to L6:
K1. A first flank of a tooth gap of the face coupling workpiece is finish machined using a first cutting edge or using a first grinding surface of the tool while, quasi-simultaneously, a second, opposing flank of the same tooth gap is pre-machined using a second cutting edge or using a second grinding surface of the tool. This is performed, for example, in a first (machine) setting;
K2. then, for example, the (machine) setting is changed in the scope of a relative setting movement and machining of the same tooth gap, for example, using a second (machine) setting follows. In the scope of this machining, the second, opposing flank of the tooth gap is finish machined using a second cutting edge or using the second grinding surface of the tool;
K3. then, for example, an exiting movement, an indexing movement (for example, by one tooth gap), and a broaching movement of the face coupling workpiece are performed as a relative setting movement; and
K4. steps K1 to K3 are repeated until all tooth flanks have been finish machined.

The method sequence K1 to K4 is also referred to here as a gap-based semi-completing single indexing method, because here machining is performed gap by gap.

The adjustment of the (machine) setting in step K2 can be performed, for example, in the tooth gap or outside the tooth gap. If the adjustment is performed outside the tooth gap, the relative setting movement can thus comprise an exiting movement, an adjustment of the (machine) setting, and a broaching movement.

The method sequence L1 to L6 can comprise the following steps:
L1. A first flank of a first tooth gap of the face coupling workpiece is finish machined using a first cutting edge or using a first grinding surface of the tool, while quasi-simultaneously a second, opposing flank of the first tooth gap is pre-machined using a second cutting edge or using a second grinding surface of the tool. This is performed, for example, in a first (machine) setting;
L2. then, an indexing movement, for example, an exiting movement, an indexing movement (for example, by one tooth gap), and a broaching movement of the face coupling workpiece are performed as a relative setting movement;
L3. a first flank of a further tooth gap (for example, a tooth gap which follows immediately after the first tooth gap) of the face coupling workpiece is finish machined using a first cutting edge or using the first grinding surface of the tool, while quasi-simultaneously a second, opposing flank of the further tooth gap is pre-machined using a second cutting edge or using the second grinding surface of the tool. This is performed in a first (machine) setting;
L4. then, an indexing movement, for example, an exiting movement, an indexing movement (for example, by one tooth gap), and a broaching movement of the face coupling workpiece are performed as a relative setting movement;
L5. steps L1 to L4 are repeated until all tooth gaps have been machined the first time; and
L6. each of the tooth gaps which was previously machined using the first (machine) setting is then subjected to machining using the second (machine) setting, wherein relative setting movements are also again performed here between the individual tooth gaps.

The adjustment of the (machine) setting in step L6 can be performed, for example, in the tooth gap or outside the tooth gap.

The method of steps L1 to L6 is also referred to here as a gap-encompassing semi-completing single indexing method, in which, for example, all concave tooth flanks of all tooth gaps are finish machined in a first pass, before all convex tooth flanks of all tooth gaps are then finish machined in a second pass.

The semi-completing method according to K1 to K4 comprises, in some embodiments, that two machining steps are executed in short succession per tooth gap, before an exiting movement, an indexing movement, and a broaching movement follow as relative setting movements.

The disclosed semi-completing single indexing method was previously not applied in the case of face couplings. In this case, this is a single indexing method which is used for milling and/or grinding the gear teeth of face coupling workpieces. The two opposing flanks of a tooth gap of the face coupling workpiece to be machined are machined using the same tool but using different machine settings (by cutting or grinding).

The semi-completing single indexing method is classified as a discontinuous method, because indexing movements are required in each case from gap to gap.

The semi-completing single indexing method of at least some embodiments can be used in untoothed face coupling workpieces or also in previously toothed face coupling workpieces.

The semi-completing single indexing method of at least some embodiments can be used with a single cut strategy, since the face coupling workpieces have a small tooth height (compared to bevel gear workpieces). Because of the small tooth height, only relatively little material has to be removed per tooth flank in a face coupling workpiece. Therefore, a tooth gap can be finish machined using only one broaching movement in a first machine setting and only one broaching movement in a second machine setting.

The semi-completing single indexing method of at least some embodiments has the advantage that face couplings can be produced by this method, which have a higher flexibility in the matter of the number of teeth than the Curvic® couplings mentioned at the outset. In addition, the face couplings may be ground, i.e., the tooth flanks of the face couplings can be hard-fine machined if needed.

The semi-completing single indexing method of at least some embodiments also has the advantage that multiple different workpieces, which are all assigned to a defined module range, can be machined using a standardized tool.

In at least some embodiments, a set having multiple standardized tools is offered/provided, to be able to machine face couplings having different modules using this set. The set of standardized tools only comprises a small number of different tools, which means that certain sacrifices have to be made in this case in the matter of a non-positive lock (i.e., in the matter of contact pattern) between the two halves of a face coupling. In contrast to bevel gear pairs, this does not involve the rolling of two bevel gears here, but rather a quasi-static non-positive lock between two face coupling elements.

The nominal radii of the standardized tools of a toolset can be constant, for example. Then, for example, face coupling gear teeth having module 4.5 to 5.5 can be machined using a first tool and face coupling gear teeth having module 5.5 to 6.5 can be machined using a second tool.

At least some embodiments enable the tool assortment to be simplified, because multiple slightly different workpieces (within a defined module range) may be machined using one tool. Slightly different workpieces (which are also referred to here as similar workpieces) as contemplated herein are workpieces the modules of which deviate only slightly from one another, i.e., the modules of the workpieces are part of the same module range.

An (end face) milling cutter head is used in at least some embodiments, which is equipped (on the end face) with at least one stick blade, wherein the stick blade has a cutting head, on which an outer cutting edge and an inner cutting edge are arranged so that a positive tip width results between these two cutting edges.

To make the method more productive, an (end face) milling cutter head may be used in at least some embodiments, which is equipped (on the end face) with multiple stick blades, wherein each of these stick blades has a cutting head, on which an outer cutting edge and an inner cutting edge are arranged so that a positive tip width results between these two cutting edges. The stick blades can be arranged in at least some embodiments in a uniform or non-uniform angle distance (on the end face) on the cutter head.

It is a further advantage of some embodiments that the crowning of the teeth of the face couplings can be selected essentially freely.

It is a further advantage of some embodiments that the flanks of the face couplings may be optimized independently of one another.

Semi-completing single indexing methods disclosed herein also have the advantage that they can be used on (conventional) bevel gear machines.

The semi-completing single indexing method is particularly suitable for small series, because one of the standardized tools can be taken to machine desired gear teeth.

The semi-completing single indexing method has the advantage that tools can be used which are simpler than in the case of the cyclo-palloid, Oerlikon, and Curvic® coupling methods mentioned at the outset.

### DRAWINGS

FIG. 1A shows a top view of a first face coupling, wherein only four teeth and three tooth gaps are shown (the four teeth are emphasized in FIG. 1A by a pattern);

FIG. 1B shows an axial section through the first face coupling according to FIG. 1A;

FIG. 1C shows the index plane of the tool through the design point, wherein the index plane of the tool is inclined in relation to the index plane of the workpiece by the machine base angle κ;

FIG. 1D shows an enlarged portion of FIG. 1C, wherein further details are shown on the basis of this enlargement;

FIG. 1E shows a perspective view of a single tooth gap of a face coupling;

FIG. 2A shows a schematic section through two cutting edges, wherein this illustration is used to derive certain embodiments of the invention;

FIG. 2B shows a schematic normal section through a cutting head;

FIG. 3 shows a schematic perspective view of an exemplary (stick) blade;

FIG. 4 shows a top view of an exemplary stick blade cutter head, which is equipped here with twelve stick blades;

FIG. 5 shows a very schematic side view of an exemplary cup grinding wheel, wherein a part of the cup grinding wheel is shown in section;

FIG. 6A shows a view of the index plane of a face coupling before carrying out the method according to certain embodiments of the invention;

FIG. 6B shows a view of the index plane of the face coupling of FIG. 6A, after the convex tooth flank of a first tooth gap has been finish machined;

FIG. 6C shows a view of the index plane of the face coupling of FIG. 6B, after the convex tooth flank of a second tooth gap has been finish machined;

FIG. 6D shows a view of the index plane of the face coupling of FIG. 6C, after the convex tooth flanks of all tooth gaps have been finish machined;

FIG. 6E shows a view of the index plane of the face coupling of FIG. 6D, after the convex tooth flank of the first tooth gap has been finish machined;

FIG. 6F shows a view of the index plane of the face coupling of FIG. 6E, after the concave tooth flanks of all tooth gaps have been finish machined;

FIG. 7A shows a view of the index plane of a face coupling before carrying out the method according to certain embodiments of the invention;

FIG. 7B shows a view of the index plane of the face coupling of FIG. 7A, after the convex tooth flank of a first tooth gap has been finish machined;

FIG. 7C shows a view of the index plane of the face coupling of FIG. 7B, after the concave tooth flank of the first tooth gap has been finish machined;

FIG. 7D shows a view of the index plane of the face coupling of FIG. 7C, after the convex tooth flank of a second tooth gap has been finish machined;

FIG. 7E shows a view of the index plane of the face coupling of FIG. 7D, after the concave tooth flank of the second tooth gap has been finish machined; and

FIG. 7F shows a view of the index plane of the face coupling of FIG. 7E, after the tooth flanks of all tooth gaps have been finish machined.

### DETAILED DESCRIPTION

Terms are used in conjunction with the present description which are also used in relevant publications and patents. However, it is to be noted that the use of these terms is only to serve for better comprehension. The inventive concepts are not to be limited by the specific selection of the terms. At least some embodiments of the invention may be readily transferred to other term systems and/or technical fields. The terms are to be applied accordingly in other technical fields.

In the scope of the present invention, both gear cutting tools 100 having defined cutting edges and also grinding tools 200 having grinding surfaces can be used. In conjunction with the following description, details of embodiments are firstly described in which cutter head gear cutting tools 100 or solid tools are used. Subsequently, the description is also expanded to grinding tools 200.

The reference sign 10 is used here both for the face coupling workpiece and also for the finish machined face coupling elements.

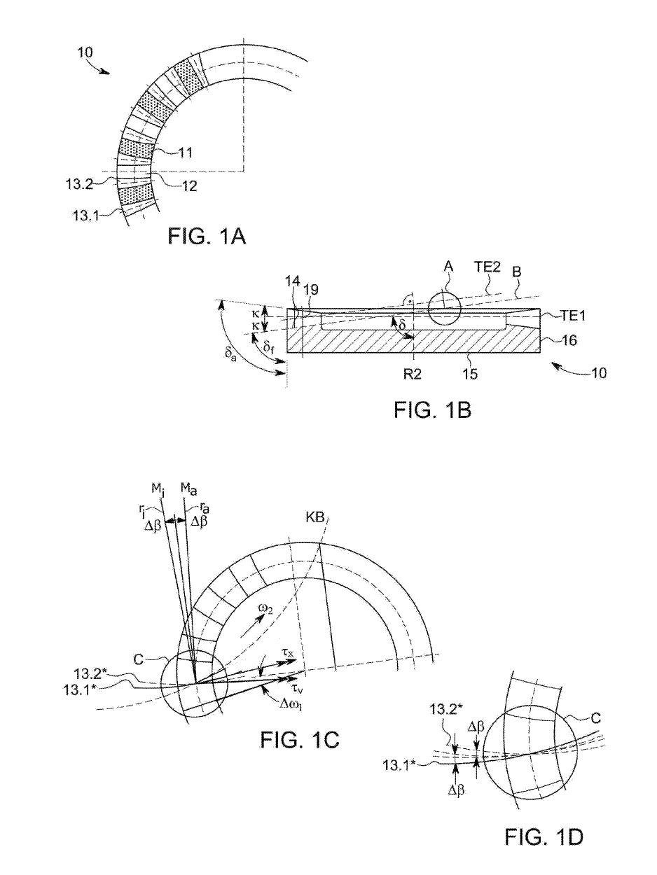

FIG. 1A shows a top view of a portion of a first face coupling workpiece 10. The teeth 11 are provided with a pattern to visually emphasize them. Four teeth 11 and three tooth gaps 12 can be seen. FIG. 1B shows an axial section through the first face coupling workpiece 10. In FIG. 1A, the short dashed curve sections show the flank lines of the concave flanks 13.2 and the convex flanks 13.1 in the index plane TE1 of the face coupling workpiece 10, wherein one concave flank 13.2 together with one convex flank 13.1 defines each tooth 11. The tool rotational movement is identified in FIG. 1C with ω₂. The gear cutting tool 100 is not shown in FIGS. 1A-1E. However, the movements of the gear cutting tool 100 are shown here.

The relative location of the gear cutting tool 100 in relation to the face coupling workpiece 10 is defined by the instantaneous setting of the machine, in which the face coupling workpiece 10 is machined by milling. This setting is referred to here as the first machine setting. The milling machining results in that the gear cutting tool 100 is rotationally driven about a rotation center Mᵢ or Mₐ, as shown in FIG. 1C by the tool rotational movement ω₂.

The semi-completing single indexing method is a discontinuous method, because the face coupling workpiece 10 does not rotate with the gear cutting tool 100 during the machining (i.e., the machining of each tooth flank).

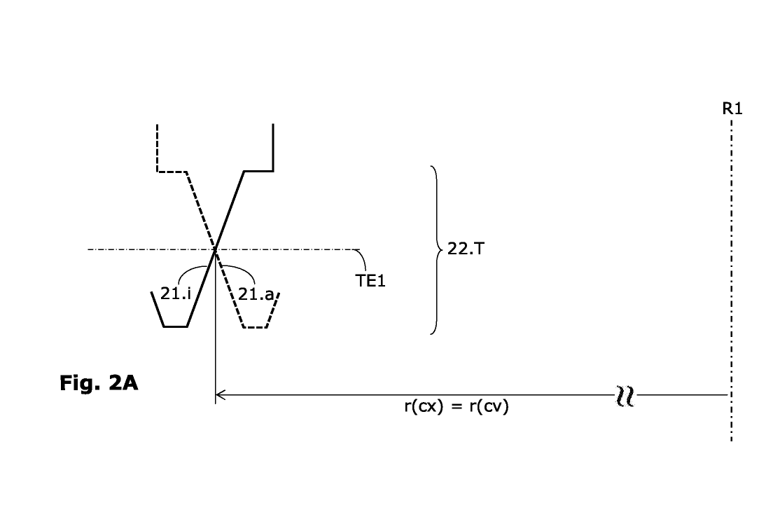

In the coordinate system of the tool 100, the cutting heads 22 of the blades 20 (see FIG. 2B) move along circular rotation circles, the radius of which is determined by the distance of the cutting head 22 from the tool rotational axis R1. During performance of certain embodiments of the invention, the tool 100 is inclined in relation to the face coupling workpiece 10. Therefore, the cutting heads 22 move along elliptical flight paths during the rotational driving ω₂ of the gear cutting tool 100, if one observes the movement thereof from the position of the face coupling workpiece 10.

Variables which are identified here with a v each relate to the concave flanks 13.2 of the face coupling workpiece 10. Variables which are identified here with an x each relate to the convex flanks 13.1 of the face coupling workpiece 10. Additionally, variables which are identified here with an i relate to inner cutting edges or inner grinding surfaces and variables which are identified here with an a relate to outer cutting edges or outer grinding surfaces.

Only a portion of a circular arc is shown in FIG. 1C of the gear cutting tool 100, which is defined by the tool radius rᵢ and is provided here with the reference sign KB. The tool radius rᵢ is associated with the inner cutting edges 21.i of the gear cutting tool 100, which are used for machining the convex tooth flanks 13.1 and the tool radius rₐ is associated with the inner cutting edges 21.a of the gear cutting tool 100, which are used for machining the concave tooth flanks 13.2.

It is to be noted here that FIG. 1C shows the special case without tool inclination (i.e., here τ=0). The path KB of the gear cutting tool 100 is therefore a circle in the index plane TE through the design point 19 (see FIG. 1B) and the base path B of the blade tips is a straight line in FIG. 1B. With a tool inclination (i.e., with τ≠0), the path KB becomes an ellipse and the base path B of the blade tips also becomes an ellipse. The gear cutting tool 100 is inclined by the angle τ about the rotation vector, which is perpendicular to the tool radius.

The rotation center for machining the convex tooth flanks 13.1 is identified as Mᵢ and for machining the concave tooth flanks 13.2 is identified as Mₐ (see FIG. 1C). It can already be seen from the fact that there are two different rotation centers Mᵢ and Mₐ that the convex tooth flanks 13.1 are machined using a different machine setting (for example, using a first machine setting) than concave tooth flanks 13.2 (which are machined, for example, using a second machine setting).

The names “first machine setting” and “second machine setting” are not to specify a sequence here, but rather these names are merely used to be able to differentiate the two machine settings.

During the cutting of the concave flanks 13.2, because of a different machine setting in the index plane of the tool, an epicycloid flight path 13.2* of the outer cutting edge 21.a results. The flank lines in the form of circular arcs are shown by dot-dash lines in FIG. 1A and FIG. 1E. The circular arcs in the tool index plane of the concave flanks 13.2 are shown by dashed lines in FIGS. 1C and 1E and deviate from the flank lines of the index plane TE1 of the workpiece by the spiral angle difference Δβ.

In FIG. 1C, the rotation circles are projected in the plane of the drawing, wherein the plane of the drawing corresponds to the index plane TE1 of the face coupling workpiece 10. Because the flight paths are ellipses, as already noted, the radii rᵢ and rₐ thereof are variable, if one observes the flight paths from a coordinate system of the face coupling workpiece 10. For the milling machining (or for the grinding machining) of the convex flanks 13.1, the effective radius 13.1* of the inner cutting edge 21.i of the cutting head 22 is important, which is defined as the normal on the convex flank 13.1 of the face coupling workpiece 10 in the index plane TE1.

It is to be noted here that the illustration of FIGS. 1A, 1C, 1D, and 1E is schematic. The profile of the flight paths shown is illustrated exaggerated.

While the so-called inner cutting edge 21.i of the cutting head 22 moves along the flight path 13.1*, the outer cutting edge 21.a of the same cutting head 22 moves along the flight path 13.2*. This flight path 13.2* is associated with a corresponding effective radius on the concave flank 13.2 of the face coupling workpiece 10 in the index plane TE1. The following conditions apply here: A: The two flight paths 13.1* and 13.2* are in a common plane, which results because an inner cutting edge 21.i and an outer cutting edge 21.a are provided on each cutting head 22, and the cutting heads 22 are arranged along a circle on the tool 100; B: The two flight paths 13.1* and 13.2* are both concentric to the respective rotation center Mᵢ and Mₐ; and C: The inner cutting edge 21.i and the outer cutting edge 21.a of a common cutting head 22 move at the same angular velocity during the machining of the material of the face coupling workpiece 10.

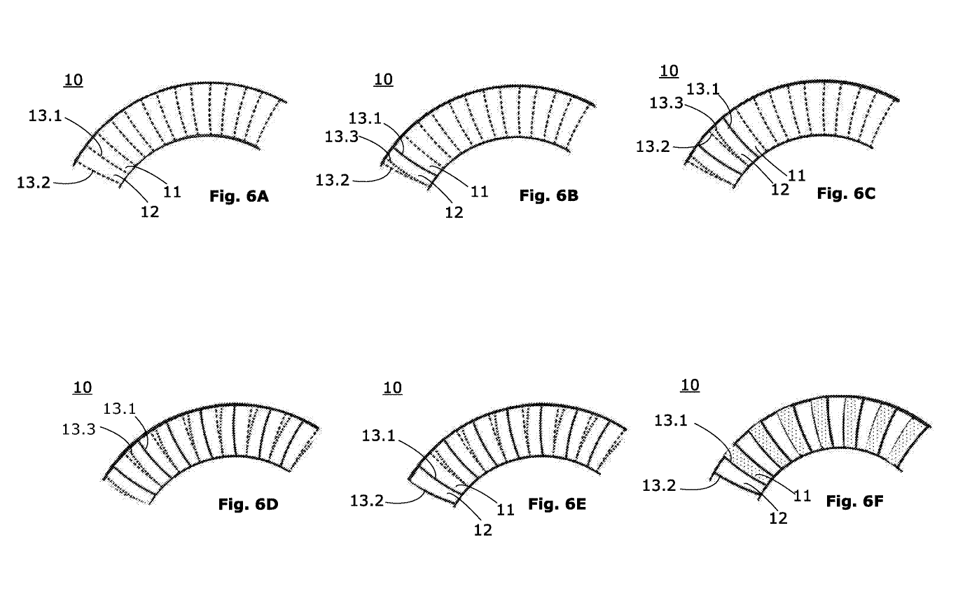

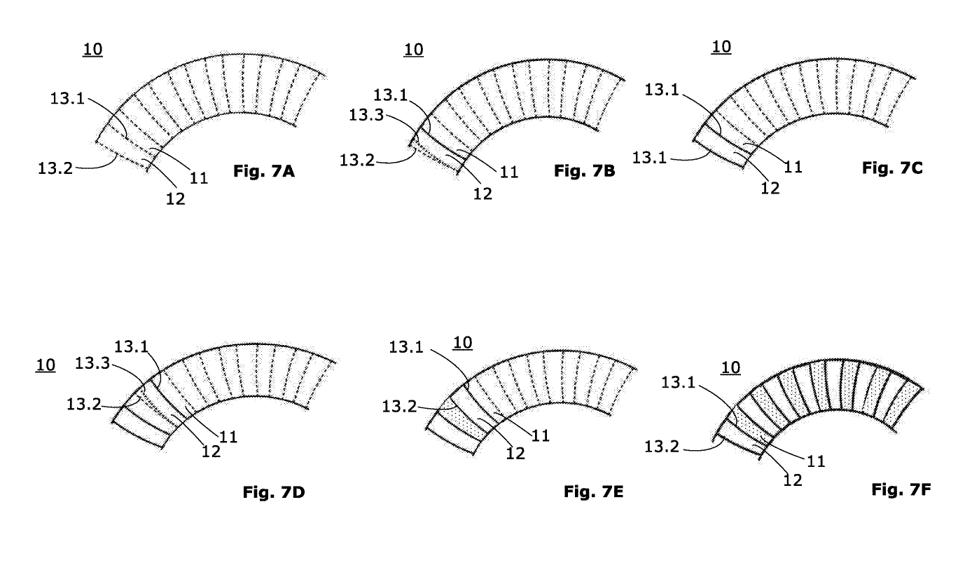

Depending on the method, the machining of the tooth flanks can be performed using a constant broaching advance, using a variable broaching advance (for example, degressively decreasing), or using multiple steps. Because it is typically a face coupling workpiece 10, which was not previously toothed, at the same time as the finish machining of the convex flanks 13.1, the convex tooth flank 13.2 of the same tooth gap 12 is machined using an outer cutting edge 21.a of the same cutting head of 100. Because in this phase of the exemplary method, the concave tooth flank 13.2 has not yet received its final form, this machining, which is performed in the scope of the first machine setting, is also referred to as pre-machining. Further details in this regard can be inferred, for example, from FIGS. 6A to 6F and 7A to 7F.

It is to be noted that the dimensions of the cutting head 22 (especially the location of the inner cutting edge 21.i and the outer cutting edge 21.a, and also the tip width sₐ₀) and the machine kinematics are specified so that the outer cutting edge 21.a does not cut excessively far into the material of the face coupling workpiece 10 during the pre-machining of the concave tooth flank 13.2. In FIGS. 6B and 7B, a pre-machined concave tooth flank is provided with the reference sign 13.3.

A second machine setting is now set in the machine and the step described hereafter follows. The concave tooth flank 13.2 of the same tooth gap 12 is then finish machined in this step using an outer cutting edge 21.a of the gear cutting tool 100.

As needed, a gap-based approach (see, for example, FIGS. 7A to 7F) or a gap-encompassing approach (see FIGS. 6A to 6F) can be applied. Details will be described hereafter.

The cutting head 22 of the gear cutting tool 100 is in some embodiments guided in at least some embodiments along an inclined path B (see FIG. 1B) through the tooth gap 12 of the face coupling 10. This aspect is to be considered when specifying the first and the second machine settings. The machine base angle κ, which influences the profile of the inclined path B, is ideally identical in both machine settings, to avoid an offset or a step in the region of the tooth base 14 of the tooth gaps 12.

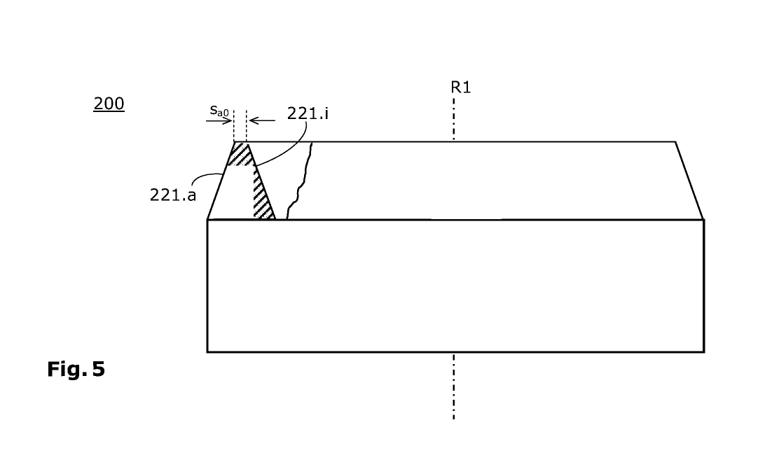

Because of the fact that in the method of some embodiments, the cutting edges 21.i, 21.a of the gear cutting tool 100 are seated on permanently defined rotation circles of the gear cutting tool 100, which are concentric to one another, the gear cutting tool 100 can also be replaced by a grinding tool 200, which does not have defined cutting edges. Because of the overall configuration, a cup grinding wheel is suitable as the grinding tool 200 (see FIG. 5), wherein instead of the mentioned inner cutting edges 21.i, an inner grinding surface 221.i and, instead of the mentioned outer cutting edges 21.a, an outer grinding surface 221.a are used (see FIG. 5). Where the cutting edges 21.i, 21.a of the grinding tool 100 define a positive tip width sₐ₀ (see FIG. 2B), the cup grinding wheel 200 has a positive profile width sₐ₀. Details in this regard can be inferred from schematic FIG. 5. The inner grinding surface 221.i and the outer grinding surface 221.a are concentric to the tool rotational axis R1 in the cup grinding wheel.

A face coupling 10 which was manufactured according to the method of some embodiments may comprise the following features. Reference is made here to FIG. 1B. Such a face coupling 10 might have, in at least some embodiments, an index cone angle δ, which is 90°. In FIG. 1B, the corresponding index plane TE1 is illustrated by a dot-dash line which extends perpendicularly to the workpiece rotational axis R2.

The face coupling 10 has teeth 11 having variable tooth head height, as can be seen in FIGS. 1B and 1E, i.e., the teeth 11 are conical; the teeth 11 can be machined by milling and/or by grinding; the teeth 11 can be reground (fine machined) in the scope of optional hard-fine machining; and the tooth gaps 12 have a base plane, or a tooth base 14, respectively, which is inclined, as can be seen in FIGS. 1B and 1E. The inclination of the tooth base 14 results, inter alia, because if needed the machine base angle κ can be set so that the cutting head 22 of a blade 20 of the gear cutting tool 100 is guided along an inclined path B (as already noted) through the tooth gap 12 of the face coupling 10. This inclined path B is diagonal to the index plane TE1 in an axial section of the face coupling 10 (see FIG. 1B). The base cone angle δ_{f} at the tooth base 14 is δ_{f}=δ−κ here. The inclined path B is intentionally selected so that reverse cutting of the face coupling 10 due to continued running of a cutting head 22 is avoided. The path B represents profile of the blade tip 23 of the cutting head 22. In FIG. 1B, it can be seen in region A that the blade tip 23 of the cutting head 22 is guided along the inclined path B through the three-dimensional space so that the blade tip 23 only removes material of the face coupling workpiece 10 in the region of the tooth gap presently to be machined.

The tooth base 14 of the face coupling workpiece 10 has a slope which increases from the heel (i.e., starting from the enveloping surface 16) in the direction of the workpiece rotational axis R2.

The convex and the concave tooth flanks 13.1, 13.2 do not have a profile in the form of a circular arc, but rather an elliptical profile.

In conjunction with FIG. 1B, it is to be noted that the projection of the inclined path B in the plane of the drawing is not a straight line, but rather a slightly curved path. Therefore, reference is made here to the fact that this inclined path B, in an axial section through the face coupling workpiece 10, is essentially parallel to the profile of the tooth base 14 of the tooth gap 12 presently to be machined.

In addition, the tooth flanks of the face couplings 10 have a crowning, the tooth flanks have a circular arc shape, and the face couplings 10 are self-centering.

The further details of the face coupling 10 of FIGS. 1A to 1E are not characteristic of the invention and are therefore only to be understood as examples. The face coupling 10 shown by way of example has, for example, a rear installation surface 15, which can be completely flat. No transition surface is provided in this example at the heel between the enveloping surface 16 and the installation surface 15, which is sometimes routine. The enveloping surface 16 thus merges at a right angle into the installation surface 15 here. The head cone angle δₐ is greater than 90° in the example shown and the base cone angle δ_{f} is less than 90°. The tooth height decreases continuously from the heel to the toe (i.e., from the outside to the inside). However, there are also embodiments in which the head cone angle δₐ is equal to 90° (not shown here, however).

The face coupling 10 of FIG. 1A has a right-spiral tooth shape. A counterpart to be paired therewith has to have a left-spiral tooth shape.

A theoretical intermediate step will be described on the basis of FIG. 2A, which leads to some embodiments of the present invention. To be able to pair two coupling halves with one another, the tooth flanks have to be conjugated to one another. It results from gear cutting theory in this case that the tool radii have to intersect in the index plane TE1 to produce conjugated tooth flanks in the single indexing method. In FIG. 2A, a corresponding normal section through a theoretical cutting head 22.T is shown. The theoretical location of the inner cutting edge 21.i is shown as a solid line. The theoretical location of the outer cutting edge 21.a is shown as a dashed line. It can be seen that the two cutting edges 21.i and 21.a intersect in the index plane TE1. To implement this in practice, the inner cutting edge 21.i has to be arranged on a first cutting head and the outer cutting edge 21.a has to be arranged on a second cutting head. In other words, in the indexing method, the face coupling workpieces would have to be gear cut using two different tools, to meet the condition of FIG. 2A.

At least some embodiments intentionally follow another path here, because it is designed to provide the most cost-effective solution possible. To reduce the tool expenditure in relation to previously known approaches, it was a goal of the invention to manage using the fewest possible different tools.

FIG. 2B shows a normal section through a cutting head 22 of a tool 100. It is a schematic illustration which is used to define further features. The cutting head 22 of a tool 100 is essentially defined by two cutting edges (called outer cutting edge 21.a and inner cutting edge 21.i) and the blade tip 23. In contrast to FIG. 2A, the outer cutting edge 21.a and the inner cutting edge 21.i were shifted in relation to one another so that they can be combined in one tool 100, or in one cutting head 22, respectively. The point of intersection of the two straight lines, which respectively define the profile of the outer cutting edge 21.a and the inner cutting edge 21.i in FIG. 2B, is outside the material of the cutting head 22. Therefore, the cutting head 22 has a positive tip width sₐ₀, as shown in FIG. 2B. The location of the index plane TE1 is also shown. The above-mentioned flight paths of the tool 100, 200 can be defined via the radii rᵢ and rₐ on the basis of the intersection points of the index plane TE1 with the outer cutting edge 21.a and with the inner cutting edge 21.i.

The inner and outer cutting edges 21.i and 21.a are thus moved apart until a practically implementable cutting head 22 having a tip width sₐ₀ results, which is positive. However, at first glance, it is a disadvantage of such a configuration of the two cutting edges 21.i and 21.a on a common cutting head 22 that the difference of the two radii rᵢ and rₐ produces a longitudinal crowning of flanks on the face coupling workpiece 10. However, it has been shown that this longitudinal crowning can be entirely or substantially reduced by setting a respective suitable angle of inclination τ (called tilt) of the tool 100, 200 in relation to the face coupling workpiece 10 when specifying the machine setting.

By specifying a suitable machine setting with τ≠0, the longitudinal crowning of the teeth of the face coupling workpieces 10 can be selected substantially freely. It is to be noted here that the two face coupling elements which are paired with one another do not roll on one another, but rather they are fixedly paired with one another. As a result, the longitudinal crowning of the teeth is not as critical as in the case of bevel gear pairs, for example.

In other words, in the face coupling workpieces 10, the longitudinal crowning of the teeth does not necessarily have to be at the ideal point (ascertained by computer). A particularly advantageous implementation results from this determination, which further reduces the tool expenditure, by providing standardized tools 100, 200.

A standardized tool is, in conjunction with the present invention, a tool which was designed so that it is usable for the milling or grinding machining of more than only one type of face coupling workpiece 10.

A standardized tool 100, 200 is, in conjunction with the present invention, for example, a tool 100, 200 which is offered with only two different engagement angle steps (for example, 21° and 19°). Or a standardized tool 100, 200 produces face coupling workpieces 10 in each case, the tooth heights of which are identical. A standardized tool 100, 200 can also, however, be offered in various steps, for example, with respect to the positive tip width sₐ₀ or the positive profile width Sₐ₀.

In other words, a standardized tool 100 or 200 can be used to machine multiple similar face couplings 10, which differ slightly from one another, however.

Thus, the face couplings 10 can be similar, for example, in that they have a gap width in the tooth base 14 which is identical because of the positive tip width sₐ₀ or the positive profile width sₐ₀.

Thus, the face couplings 10 can be similar, for example, in that they have a module which is similar. A first standardized tool 100 or 200 can be used, for example, to manufacture face coupling workpieces which have a module=3.5. The same standardized tool 100 can also be used to manufacture similar face coupling workpieces which have a module=4.5. The standardized tool 100 or 200 can therefore be used, for example, for manufacturing face coupling workpieces 10 which have a module in the range between 3.5 and 4.5. A further standardized tool 100 or 200 can be used, for example, for manufacturing face coupling workpieces 10, which have a module in the range between 4.6 and 6. This means that a specific module range can be covered using each of these standard tools 100, 200.

In at least some embodiments, such standardized tools can be used as the gear cutting tool 100 or as the grinding tool 200 to manufacture multiple similar face coupling workpieces 10.

The present invention, as already noted, is a semi-completing single indexing method. The two opposing flanks 13.2, 13.1 of a tooth gap 12 of the face coupling workpiece 10 to be machined are finish machined using the same tool 100, but using different machine settings. This machining can performed in each case in direct chronological succession, or the individual machining steps can be chronologically separated from one another, for example, by multiple exiting movements, indexing movements, and infeed movements (broaching movements).

The example of a gap-encompassing machining method will be described on the basis of FIGS. 6A to 6F. Only a small portion of a face coupling workpiece 10 is shown in schematic form in various machining phases in each of these figures.

FIG. 6A shows a view of the index plane TE1 of a face coupling workpiece 10 before carrying out the method of certain embodiments. The intended profile of the tooth flanks is shown by dashed lines in the index plane TE1. The reference sign 13.2 identifies the intended profile of a concave tooth flank and the reference sign 13.1 identifies the intended profile of a convex tooth flank here. The tooth gap 12 is located between these two flanks 13.2, 13.1. The reference sign 11 identifies an adjacent tooth here.

FIG. 6B shows the face coupling workpiece 10 of FIG. 6A, after a first convex tooth flank 13.1 of a first tooth gap 12 has been finish machined. The finish machined tooth flanks are shown as solid curves. While an inner cutting edge 21.i of the tool 100 finish machines the first convex tooth flank 13.1, the first concave tooth flank 13.2 is pre-machined by the outer cutting edge 21.a of the same tooth head 22. The pre-machined tooth flanks are shown as dotted curves 13.3. It can be seen on the basis of FIG. 6B that the profile of the pre-machined first concave tooth flank 13.3 is not congruent with the intended profile of the concave tooth flank 13.2.

A relative indexing movement of the face coupling workpiece 10 about the workpiece rotational axis R2 now follows. The previously used machine setting remains in place.

FIG. 6C shows the face coupling workpiece 10 of FIG. 6B, after a second convex tooth flank 13.1 of a second tooth gap 12 has been finish machined and a second concave tooth flank has been pre-machined.

FIG. 6D shows the face coupling workpiece 10 of FIG. 6C, after all convex tooth flanks 13.1 of all tooth gaps 12 have been finish machined and all concave tooth flanks have been pre-machined. Before the machining of each tooth gap 12, an indexing movement is performed in each case, while the machine setting remains in place.

These machining steps are all performed using a first machine setting. A second machine setting is now specified to finish machine the pre-machined concave tooth flanks 13.3.

FIG. 6E shows the face coupling workpiece 10 of FIG. 6D, after the first concave tooth flank 13.2 of the first tooth gap 12 has been finish machined. The finish machined tooth flanks are shown as solid curves.

An indexing movement of the face coupling workpiece 10 about the workpiece rotational axis R2 also occurs between each of the steps.

FIG. 6F shows the face coupling workpiece 10, after all concave tooth flanks 13.2 of all tooth gaps 12 have been finish machined. The teeth 11 are provided with a pattern here, to emphasize them visually more clearly.

The example of a gap-based machining method of certain embodiments will be described on the basis of FIGS. 7A to 7F. The teeth 11 are provided in FIGS. 7E and 7F with a pattern, to emphasize them visually more clearly.

FIG. 7A shows a view of the index plane TE1 of a face coupling workpiece 10 before carrying out the method according to certain embodiments. FIG. 7A corresponds to FIG. 6A, to the description of which reference is made here.

FIG. 7B corresponds to FIG. 6B, to the description of which reference is made here.

FIG. 7C shows the face coupling workpiece 10 of FIG. 7B, after the first concave tooth flank 13.2 of the first tooth gap 12 has been finish machined. To enable this, a changeover from the first to the second machine setting is performed, before a cutting head 22 has again been guided to the first tooth gap 12. An indexing movement is not performed.

To be able to now machine the next tooth gap 12, a changeover is performed from the second to the first machine setting, and an indexing movement is executed.

FIG. 7D shows the face coupling workpiece 10 of FIG. 7C, after a second convex tooth flank 13.1 of the second tooth gap 12 has been finish machined. During this pass, the second concave tooth flank 13.2 of the second tooth gap 12 has been pre-machined (identified with 13.3).

To now be able to finish machine the second tooth gap 12, a changeover is again performed from the first to the second machine setting. FIG. 7E shows the face coupling workpiece 10 of FIG. 7D, after the second tooth gap 12 has also been finish machined.

FIG. 7F corresponds to FIG. 6F, to the description of which reference is made here.

To reduce the time expenditure, which is required for the respective adjustment of the machine setting and/or carrying out the indexing movement, other (alternating) method sequences can also be applied here. The methods shown are each only to be understood as examples. Instead of beginning with the finish machining of a convex tooth flank 13.1, at least some embodiments can also begin with the finish machining of a concave tooth flank 13.2.

In FIGS. 1A to 1E, the first machine setting is defined, inter alia, by the rotation center Mᵢ and the radius rᵢ. The convex flanks 13.1 are finish machined and simultaneously the concave tooth flanks 13.2 are pre-machined using this first machine setting. In the first machine setting, the inner cutting edges 21.i follow an elliptical flight path with radius rᵢ around the rotation center Mᵢ and the outer cutting edges 21.a follow another elliptical flight path around the same rotation center Mᵢ.

These two elliptical flight paths span a common plane, which is not parallel to the index plane TE1 of the face coupling workpiece 10, since the angle of inclination τ≠0 and the machine base angle κ≧0. This common plane is inclined as defined by the angle of inclination τ and optionally also by the machine base angle κ such that the blade tips 23 of the cutting heads 22 do not collide in the region A of FIG. 1B with the material of the face coupling workpiece 10.

The method of certain embodiments can be executed, for example, on a bevel gear cutting machine, wherein the face coupling workpiece 10 is fastened on the workpiece spindle and the tool 100 or 200 is fastened on the spindle of the bevel gear cutting machine. There are numerous different gear cutting machines (for example, 5-axis and 6-axis gear cutting machines), in which the method of certain embodiments can be carried out.

Typical variables which can define a specific machine setting in this environment are the location of the rotation center M, Mi, Ma in relation to the location of the face coupling workpiece 10 (defined, inter alia, by the axis offset); the radial; the swivel angle; the angle of inclination τ; the machine base angle κ; the rotational position of the tool rotational axis R1; the roller swaying angle; and the depth position of the tool 100 or 200 in relation to the face coupling workpiece 10.

Settings of the tool 100, 200 in relation to the face coupling workpiece/face coupling element 10 are referred to as the first and second relative settings. These terms are not to be understood as restrictive. For example, if the tool 100, 200 is broached in multiple steps to the full gap depth into the material of the face coupling workpiece/face coupling element 10, this broaching movement thus results in an additional change of the relative setting.

Upon the transition from the first to the second machine setting, at least one of the mentioned typical variables (in particular the angle of inclination τ) is changed.

The description above can also be applied to solid tools having fixed blades and not only to stick blade cutter heads. It can also be applied, as noted, to grinding tools 200, which have a cup shape.

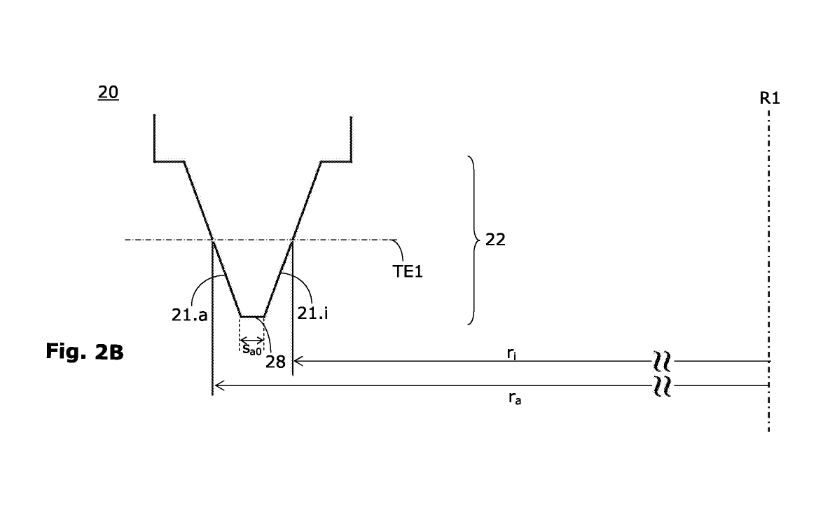

An end milling cutter head is used as the cutter head gear cutting tool 100 in at least some embodiments. The end milling cutter head is equipped with multiple stick blades 20, which protrude on the end face from the gear cutting tool 100. A stick blade 20 in at least some embodiments has a shape as shown as an example in FIG. 3. The stick blade 20 has a shaft 24. The shape of the shaft 24 is selected so that the stick blade 20 can be fastened securely and accurately in a corresponding blade groove or chamber of the cutter head gear cutting tool 100. The cross section of the shaft 24 can be rectangular or polygonal, for example.

In the head region (identified here as the cutting head 22) of the stick blade 20, a first open surface 25, a second open surface 26, a (common) rake surface 27, a head open surface 28, an inner cutting edge 21.i, an outer cutting edge 21.a, and a head cutting edge 29 are located, for example. The frontmost region of the cutting head 22 is also referred to as the blade tip 23.

The rake surface 27 intersects with the first open surface 25 in a virtual intersection line, which approximately corresponds to the profile of the inner cutting edge 21.i, or which exactly corresponds to the profile of the inner cutting edge 21.i. The rake surface 27 intersects with the second open surface 26 in a virtual intersection line which corresponds to the profile of the outer cutting edge 21.a, or which exactly corresponds to the profile of the outer cutting edge 21.a.

However, the rake surface 27 does not have to be a flat surface, as shown in FIG. 3 on the basis of a simplified illustration.

The positive tip width sa0 is selected in at least some embodiments so that in the first machine setting, the outer cutting edge 21.a does not cut into the concave flank 13.2 upon leaving the tooth gap 12. A small excess of material should always remain in place here during the pre-machining, which is then removed in the second machine setting during the finish machining of the concave flank 13.2.

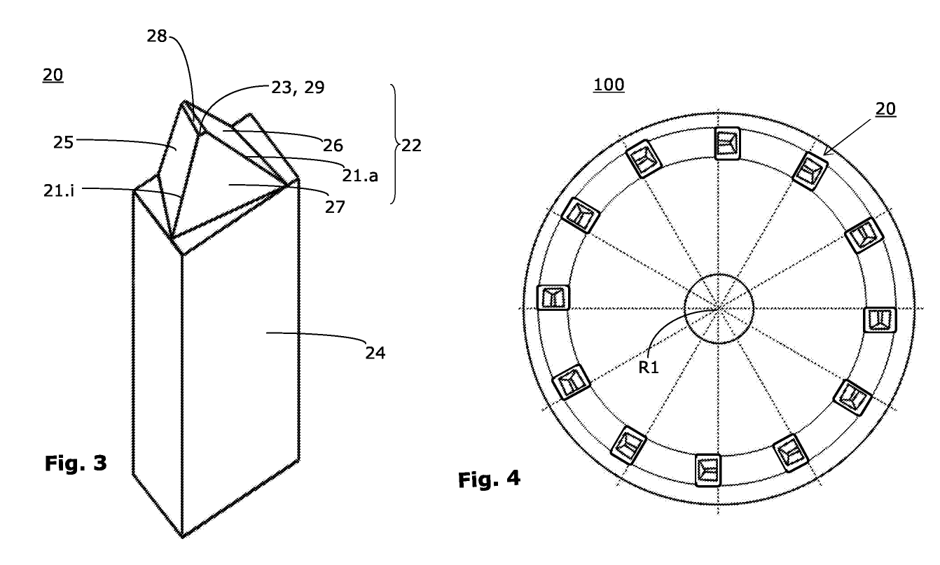

FIG. 4 shows a top view of an exemplary stick blade cutter head, which is used here as the gear cutting tool 100. The stick blade cutter head shown is equipped on the end face with 12 stick blades 20, which are all arranged at an equal angle distance along the circumference of the stick blade cutter head. As can be inferred from FIG. 4, the rake surface 27 of the individual stick blades 20 is parallel to radial sectional planes of the gear cutting tool 100. The individual stick blades 20 are not on a slope in a gear cutting tool 100 (i.e., all stick blades 20 have the same radial distance to the axis R1), because the illustrated method is a single indexing broaching method and not a continuous rolling method.

Similarly, in a cup grinding wheel 200, which is shown in FIG. 5 on the basis of a schematic example, the positive profile width sₐ₀ is selected so that the outer grinding surface 221.a of the cup grinding wheel 200 leaves a small material excess standing on the concave flank 13.2 upon leaving the tooth gap 12. This small material excess is then removed by grinding in the second machine setting during the finish machining of the concave flank 13.2.

As may be recognized by those of ordinary skill in the pertinent art based on the teachings herein, numerous changes and modifications may be made to the above described and other embodiments of the present invention without departing from the spirit of the invention as defined in the claims. Accordingly, this detailed description of embodiments is to be taken in an illustrative, as opposed to a limiting sense.

What is claimed is:

1. A method for machining the tooth flanks of a face coupling workpiece in a semi-completing single indexing process, the method comprising:
(i) executing at least one first relative setting movement between a face coupling workpiece and a gear cutting tool including at least one cutting head having a first cutting edge and a second cutting edge arranged on the at least one cutting head to define a positive tip width between the first cutting edge and the second cutting edge and, in turn, defining a first relative setting of the tool in relation to the face coupling workpiece;
(ii) finish machining a first tooth flank of a first tooth gap of the face coupling workpiece with the first cutting edge, and simultaneously pre-machining a second tooth flank of the first tooth gap with the second cutting edge,
(iii) executing at least one second relative setting movement between the face coupling workpiece and the gear cutting tool, and, in turn, defining a second relative setting of the tool in relation to the face coupling workpiece, and
(iv) finish machining, with the second cutting edge, one or more of the second tooth flank of the first tooth gap or a second tooth flank of a second tooth gap of the face coupling workpiece defining first and second tooth flanks.

2. The method according to claim 1, wherein step (ii) includes
in the first relative setting, moving each first cutting edge of the at least one cutting head along a first flight path and moving each second cutting edge of the at least one cutting head along a second flight path;
wherein the first flight path and the second flight path are located in a common plane with each other.

3. The method according to claim 2, wherein step (iv) includes
in the second relative setting, moving said each second cutting edge along a third flight path,
wherein the third flight path defines an effective radius that is larger than an effective radius of the second flight path, and
the third flight path spans a plane that is inclined in relation to the common plane of the first flight path and second flight path.

4. The method according to claim 1, wherein the step of executing at least one first relative setting movement includes one or more of setting a first machine setting; executing an exiting movement and a broaching movement; or executing an indexing movement.

5. The method according to claim 1, wherein the step of executing at least one second relative setting movement includes one or more of setting a second machine setting; executing an exiting movement and a broaching movement; or executing an indexing movement.

6. The method according to claim 1, further including, in the first and the second relative settings, inclining the tool in relation to the face coupling workpiece, and guiding the tool along an inclined path through the first tooth gap during machining thereof, wherein said inclined path, in an axial section through the face coupling workpiece, is generally parallel to a profile of a tooth base of the first tooth gap.

7. The method according to claim 6, wherein the tooth base of the first tooth gap is inclined at a machine base angle in relation to an index plane of the face coupling workpiece.

8. The method according to claim 1, wherein the method defines a gap-based semi-completing single indexing process, and further comprises the following steps:
(a) finish machining the first tooth flank of the first tooth gap using the first relative setting and finish machining the second tooth flank of the first tooth gap using the second relative setting,
(b) executing an exiting movement, an indexing rotation, and a broaching movement; and
(c) finish machining the first tooth flank of the second tooth gap using the first relative setting and finish machining the second tooth flank of the second tooth gap using the second relative setting.

9. The method according to claim 1, wherein the method defines a gap-encompassing semi-completing single indexing process, and further comprises the following steps:
(a) finish machining the first tooth flank of the first tooth gap using the first relative setting;
(b) executing an exiting movement, an indexing rotation, and a broaching movement; and
(c) finish machining the first tooth flank of the second tooth gap using the first relative setting; and
(d) after the first tooth flanks of the first and second tooth gaps have been finish machined, defining the second relative setting and finish machining the second tooth flanks of the first and second tooth gaps.

10. The method according to claim 4, wherein the step of executing at least one second relative setting movement includes one or more of setting a second machine setting; executing an exiting movement and a broaching movement; or executing an indexing movement.

11. The method according to claim 10, wherein the second machine setting differs from the first machine setting by one or more of:
a location of a rotation center of the tool in relation to a location of the face coupling workpiece;
a setting of a radial of a machine in which the method is executed;
a setting of a sway angle of a machine in which the method is executed; or
a setting of an angle of inclination of a machine in which the method is executed.

12. The method according to claim 1, wherein the tool is a cutter head gear cutting tool or a solid tool and comprises a plurality of blades, wherein each of the plurality of blades includes at least one of said at least one cutting head, said first cutting edge is defined by an inner cutting edge of said cutting head, said second cutting edge is defined by an outer cutting edge of said cutting head, and the inner cutting edge and the outer cutting edge are arranged on said cutting head to define said positive tip width.

13. The method according to claim 12, wherein
the first tooth flank defines a convex tooth flank,
the second tooth flank defines a concave tooth flank, and
the step of finish machining the first tooth flank is performed using the inner cutting edge, and the step of simultaneous premachining the second tooth flank is performed using the outer cutting edge, in the first relative setting.

14. The method according to claim 1, wherein the tool is a cutter head gear cutting tool or a solid tool and comprises a plurality of blades, each of the plurality of blades includes at least one of said at least one cutting head, said first cutting edge is defined by an outer cutting edge of said cutting head, said second cutting edge is defined by an inner cutting edge of said cutting head, and the outer cutting edge and the inner cutting edge are arranged on said cutting head to define a positive tip width.

15. The method according to claim 14, wherein
the first tooth flank defines a concave tooth flank;
the second tooth flank defines a convex tooth flank, and
the step of finish machining the first tooth flank is performed using the outer cutting edge, and the step of simultaneous premachining of the convex tooth flank of the same tooth gap is performed using the inner cutting edge, in the first relative setting.

16. The method according to claim 12, wherein all cutting heads of the blades of the gear cutting tool are located on a common circle defined by the gear cutting tool, which is arranged concentrically in relation to a rotation center of the gear cutting tool.

17. The method according to claim 1, further including, after finish machining all tooth flanks of the face coupling workpiece, hard-fine machining said all tooth flanks by a grinding process.

18. The method according to claim 1, further comprising controlling a crowning of teeth of the face coupling workpiece by setting an inclination of the tool in relation to the face coupling workpiece.

19. The method according to claim 1, further comprising compensating for spiral angle errors of the face coupling workpiece by changing one or more of the first or second relative setting.

20. A method for machining the tooth flanks of a face coupling workpiece in a semi-completing single indexing process, the method comprising:
(i) executing at least one first relative setting movement between a face coupling workpiece and a grinding tool having a first grinding surface and a second grinding surface arranged to define a positive tip width between the first grinding surface and the second grinding surface, and, in turn, defining a first relative setting of the tool in relation to the face coupling workpiece;
(ii) finish machining a first tooth flank of a first tooth gap of the face coupling workpiece with the first grinding surface, and simultaneously pre-machining a second tooth flank of the first tooth gap with the second grinding surface;
(iii) executing at least one second relative setting movement between the face coupling workpiece and the grinding tool, and, in turn, defining a second relative setting of the tool in relation to the face coupling workpiece, and
(iv) finish machining, with the second grinding surface, one or more of the second tooth flank of the first tooth gap or a second tooth flank of a second tooth gap of the face coupling workpiece defining first and second tooth flanks.

21. The method according to claim 20, wherein step (ii) includes
in the first relative setting, moving the first grinding surface along a first flight path and moving the second grinding surface along a second flight path;
wherein the first flight path and the second flight path are located in a common plane with each other.

22. The method according to claim 21, wherein step (iv) includes,
in the second relative setting, moving the second grinding surface along a third flight path,
wherein the third flight path defines an effective radius that is larger than an effective radius of the second flight path, and
the third flight path spans a plane which is inclined in relation to the common plane of the first flight path and second flight path.

23. The method according to claim 20, wherein the step of executing at least one first relative setting movement includes one or more of setting a first machine setting; executing an exiting movement and a broaching movement; or executing an indexing movement.

24. The method according to claim 20, wherein the step of executing at least one second relative setting movement includes one or more of setting a second machine setting; executing an exiting movement and a broaching movement; or executing an indexing movement.

25. The method according to claim 20, further including, in the first and the second relative settings, inclining the tool relation to the face coupling workpiece, and guiding the tool along an inclined path through the first tooth gap during machining thereof, wherein said inclined path, in an axial section through the face coupling workpiece, is generally parallel to a profile of a tooth base of the first tooth gap.

26. The method according to claim 25, wherein the tooth base of the first tooth gap is inclined at a machine base angle in relation to an index plane of the face coupling workpiece.

27. The method according to claim 19, wherein the method defines a gap-based semi-completing single indexing process, and further comprises the following steps:
(a) finish machining the first tooth flank of the first tooth gap using the first relative setting and finish machining the second tooth flank of the first tooth gap using the second relative setting,
(b) executing an exiting movement, an indexing rotation, and a broaching movement; and
(c) finish machining the first tooth flank of the second tooth gap using the first relative setting and finish machining the second tooth flank of the second tooth gap using the second relative setting.

28. The method according to claim 20, wherein the method defines a gap-encompassing semi-completing single indexing process, and further comprises the following steps:
(a) finish machining the first tooth flank of the first tooth gap using the first relative setting;
(b) executing an exiting movement, an indexing rotation, and a broaching movement;
(c) finish machining the first tooth flank of the second tooth gap using the first relative setting; and
(d) after the first tooth flanks of the first and second tooth gaps have been finish machined, defining the second relative setting and finish machining the second tooth flanks of the first and second tooth gaps.

29. The method according to claim 23, wherein the step of executing at least one second relative setting movement includes one or more of setting a second machine setting; executing an exiting movement and a broaching movement; or executing an indexing movement.

30. The method according to claim 29, wherein the second machine setting differs from the first machine setting by one or more of:
a location of a rotation center of the tool in relation to a location of the face coupling workpiece;
a setting of a radial of a machine in which the method is executed;
a setting of a sway angle of a machine in which the method is executed; or
a setting of an angle of inclination of a machine in which the method is executed.

31. The method according to claim 20, further including, after finish machining all tooth flanks of the face coupling workpiece, hard-fine machining said all tooth flanks by a grinding process.

32. The method according to claim 20, wherein the first grinding surface is defined by an inner grinding surface and the second grinding surface is defined by an outer grinding surface.

33. The method according to claim 20, wherein the second grinding surface is defined by an inner grinding surface and the first grinding surface is defined by an outer grinding surface.

34. The method according to claim 20, further comprising controlling a crowning of teeth of the face coupling workpiece by setting an inclination of the tool in relation to the face coupling workpiece.

35. The method according to claim 20, further comprising compensating for spiral angle errors of the face coupling workpiece by changing one or more of the first or second relative setting.
